(19) United States
(12) Patent Application Publication
(10) Pub. No.: US 2008/0160965 A1
(43) Pub. Date: Jul. 3, 2008

(54) METHOD OF PERFORMING COMMUNICATION IN MOBILE TERMINAL

(75) Inventors: Kang Hyun Lee, Daegu Metropolitan City (KR); Jeong Hyo Yi, Gumi-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/873,095

(22) Filed: Oct. 16, 2007

(30) Foreign Application Priority Data
Jan. 3, 2007 (KR) 10-2007-0000581

(51) Int. Cl. H04M 11/10; H04M 3/42; H04Q 7/20

(52) U.S. Cl. 455/413; 455/415; 455/452.1; 455/466

(57) ABSTRACT

A method of performing communication in a mobile terminal includes performing data communication, determining whether a release order message received while data communication is being performed indicates that there is a voice communication request, allocating a traffic channel for voice communication if the release order message indicates that there is a voice communication request, receiving the voice communication request through the traffic channel, and displaying the voice communication request.

### CROSS REFERENCE TO RELATED APPLICATION

This application claims priority from and the benefit of Korean Patent Application No. 10-2007-0000581, filed on Jan. 3, 2007, which is hereby incorporated by reference for all purposes as if fully set forth herein.

### BACKGROUND OF THE INVENTION

1. Field of the Invention

The present invention relates to a method of performing communication in a mobile terminal, and more particularly, to a method of performing communication in a mobile terminal in which a voice communication request may be received while data communication is being performed.

2. Discussion of the Background

Mobile terminals are widely used in various fields because mobile terminals can carry, store, and reproduce various application programs and have various option functions. Particularly, a mobile terminal can exchange data such as a picture, a moving picture, or a multimedia message (MMS) with a web server or another mobile terminal using a traffic channel.

However, because a mobile terminal receives data communication through a traffic channel, the mobile terminal may be unable to receive a voice communication request while performing data communication.

Therefore, a mobile terminal that is capable of receiving a voice communication request while performing data communication is desirable.

### SUMMARY OF THE INVENTION

The present invention provides a method of performing communication in a mobile terminal in which a message requesting voice communication may be received while data communication is being performed.

Additional features of the invention will be set forth in the description which follows, and in part will be apparent from the description, or may be learned by practice of the invention.

The present invention discloses a method of performing communication in a mobile terminal including performing data communication, determining whether a release order message received while data communication is being performed indicates that there is a voice communication request, allocating a traffic channel for voice communication if the release order message indicates that there is a voice communication request, receiving the voice communication request through the traffic channel, and displaying the voice communication request.

The present invention also discloses a method of performing data communication including performing data communication, setting the mobile terminal to reject voice communication requests that are received while data communication is being performed, discontinuing data communication when a release order message is received, determining whether the release order message indicates that there is a voice communication request, rejecting the voice communication request if the release order message indicates that there is a voice communication request, and allocating a channel to re-activate data communication.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram showing a configuration of a mobile terminal according to an exemplary embodiment of the present invention.

FIG. 2 is a diagram showing a data format of a release order message according to an exemplary embodiment of the present invention.

FIG. 3 is a flowchart showing a method of performing communication in a mobile terminal according to an exemplary embodiment of the present invention.

### DETAILED DESCRIPTION OF ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Hereinafter, for better comprehension and ease of description, an ‘Alert With Message Information’ is defined as a message requesting voice communication. The ‘Alert With Message Information’ may include sender information including, but not limited to, a phone number, a name, an address, a picture, and/or a nickname.

Further, a state where a mobile terminal according to an exemplary embodiment of the present invention performs data communication with a web server or another mobile terminal is referred to as an active state, and a state where the mobile terminal does not perform data communication with a web server or another mobile terminal is referred to as a dormant state.

A release order message, according to an exemplary embodiment of the present invention, is a message notifying that communication between the mobile terminal and a base station has been discontinued. The release order message is transmitted from at least one of the mobile terminal and the base station. That is, the release order message is a message transmitted from a communicating party that first discovers that communication with another party has been discontinued. The data format of the release order message is preset between the mobile terminal and the base station.

Further, the mobile terminal can perform data communication with a web server or another mobile terminal, and has a configuration that can receive voice communication information generated while performing the data communication. The mobile terminal may be a telecommunication appliance or a multimedia appliance, such as a mobile communication terminal, a Personal Digital Assistant (PDA), a smart phone, an International Mobile Telecommunication 2000 (IMT-2000) terminal, a Wideband Code Division Multiple Access (WCDMA) terminal, a Global System For Mobile Communication (GSM) terminal, an Universal Mobile Telecommunication Service (UMTS) terminal, or an application thereof.

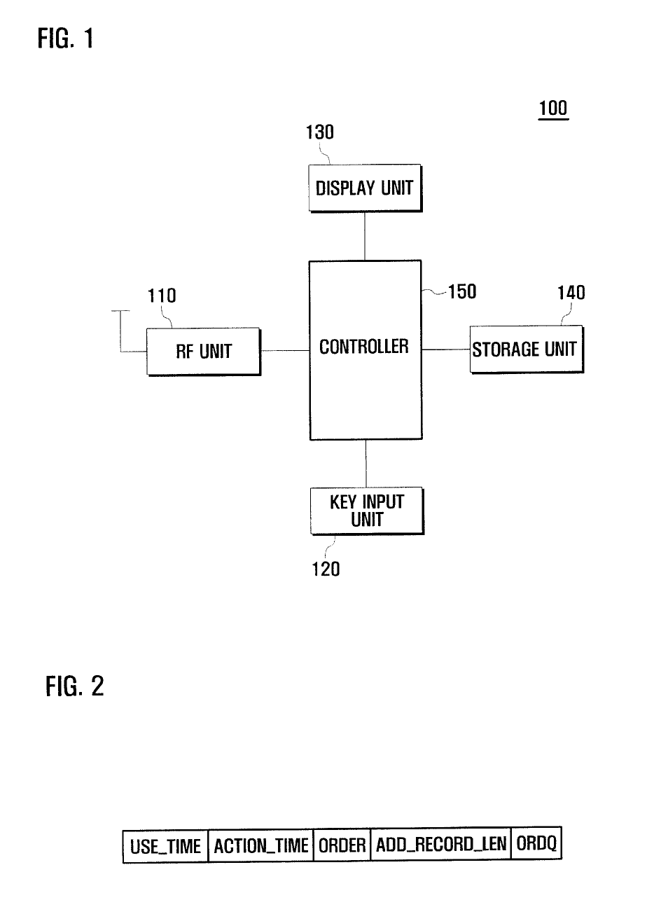

FIG. 1 is a block diagram showing a configuration of a mobile terminal according to an exemplary embodiment of the present invention.

Referring to FIG. 1, the mobile terminal 100 includes a radio frequency (RF) unit 110, a key input unit 120, a display unit 130, a storage unit 140, and a controller 150.

The RF unit 110 forms communication channels with a base station to perform data communication and voice communication with another mobile terminal, transmits user data to another mobile terminal wirelessly, and transmits and receives contents and a control signal related to the contents from a web server. The RF unit 110 may include an RF transmitter to up-convert a frequency of a signal to be transmitted and amplify the signal and an RF receiver to low-noise amplify a received signal and down-convert a frequency of the signal.

The key input unit 120 includes a plurality of input keys and function keys to input numeral or character information and set various functions. The function keys may include a direction key, a side key, and a hotkey to perform a specific function. Further, the key input unit 120 outputs a key signal input by a user to the controller 150 to allow the user to control settings and functions of the mobile terminal 100.

The display unit 130 may display various menus of the mobile terminal 100, information input by the user, and information provided to the user. The display unit 130 may be formed with a liquid crystal display (LCD), and if the LCD uses a touch screen, the display unit 130 can function as an input means.

Particularly, if the user of the mobile terminal 100 subscribes to a Caller Identification (CID) service, the display unit 130 may search for and display a caller's phone number corresponding to a message requesting voice communication (AWI_Msg), and a name matched to the phone number that is stored in a phonebook in the mobile terminal 100. If the user of the mobile terminal 100 does not subscribe to a CID service, the display unit 130 may simply display a message indicating that a phone call has been received.

The storage unit 140 temporarily or semi-permanently stores data received while data communication is being performed. The storage unit 140 includes a program area and a data area.

The program area stores an Operating System (OS) to operate the mobile terminal 100, an application program required to reproduce a multimedia content, and an option function of the mobile terminal 100, for example, a camera function, a sound reproducing function, or an image or moving picture reproducing function. When a user requests activation of a function, the mobile terminal 100 provides the requested function using the corresponding application program, which is activated by the controller 150.

The data area stores data generated through the use of the mobile terminal 100 and data such as an image or a moving picture photographed by a camera function, phone book data, audio data, and information corresponding to contents or user data.

The controller 150 controls the general operations of the mobile terminal 100 and the signal flow of units of the mobile terminal 100.

Particularly, the controller 150 controls a function related to receiving voice communication request messages during data communication. In more detail, when the controller 150 receives a release order message while performing data communication, the controller 150 checks a value stored in an Order Qualification code (ORDQ) field of the release order message.

FIG. 2 is a diagram showing a data format of the release order message according to an exemplary embodiment of the present invention.

The data format of the release order message includes a USE_TIME field, an ACTION_TIME field, an ORDER field, an ADD_RECORD_LEN field, and an ORDQ field. The ‘USE_TIME’ field indicates whether the ‘ACTION_TIME’ field is used. If the ‘USE_TIME’ field is set to 1, the ‘ACTION_TIME’ field stores an effective start time of the corresponding release order message. That is, if the ‘USE_TIME’ field contains a value of using the ‘ACTION_TIME’ field, upon executing an instruction, in order to determine a system time, the ‘ACTION_TIME’ field can be used. However, if the value of using the ACTION_TIME field is not contained in the ‘USE_TIME’ field, the ‘ACTION_TIME’ field is set to 0. The ‘ORDER’ field stores a message to indicate an instruction, for example, an instruction corresponding to the release order message. The ‘ADD_RECORD_LEN’ field stores the entire content of the corresponding release order message, and the ORDQ field stores identification information of the corresponding release order message. The currently used ORDQ field of the release order message has three values as follows: (1) [00000000] is the value transmitted when a request for terminating communication is input; (2) [00000001] is the value transmitted when communication is automatically terminated; and (3) [00000010] is the value notifying that communication requested by the user is not connected. That is, when the mobile terminal 100 discontinues data communication, a release order message is transmitted, and the ORDQ field of the release order message displays a reason why the release order message is being transmitted.

Particularly, in the ORDQ field of the release order message, a further preset value may indicate that voice communication will be received in the mobile terminal 100.

That is, if the controller 150 receives the release order message while performing data communication, the controller 150 discontinues the data communication and checks the ORDQ field value of the release order message. If the ORDQ field value indicates that voice communication will be received, the controller 150 releases a channel formed to perform the data communication and converts the mobile terminal 100 from an active state to a dormant state.

For example, when the mobile terminal 100 is transmitting or receiving data communication using a channel, the controller 150 releases the channel and allocates a traffic channel for performing the voice communication.

Further, when the controller 150 receives a message requesting voice communication (AWI_Msg) through the traffic channel, the controller 150 checks a caller's information included in the AWI_Msg message. The controller 150 notifies the user that a message requesting voice communication (AWI_Msg) has been received using the display unit 130 and a speaker (not shown). If the user accepts connection of voice communication, the controller 150 connects the mobile terminal 100 to the mobile terminal of a caller requesting the voice communication.

If the user subscribes to a CID service, the controller 150 extracts the phone number corresponding to the AWI_Msg message and determines whether the extracted phone number is stored in the phonebook of the mobile terminal 100. If the extracted phone number is stored in the phonebook, the controller 150 may output any of a name, a picture, and a phone number that are stored in the phonebook to the display unit 130, which displays the name, the picture, and/or the phone number.

Further, when the user terminates voice communication, the controller 150 releases the traffic channel that was used to perform voice communication and checks if there is data that was not transmitted or received during the data communication that was performed immediately prior to the terminated voice communication. If the of data was not completely transmitted, the controller 150 allocates a channel to receive or transmit the remaining data.

However, the controller 150 can set the mobile terminal 100 so that a voice communication request does not interrupt data communication. That is, to prevent data communication from being terminated due to a voice communication request, the mobile terminal 100 can be set to reject voice communication requests received during data communication. When set in this manner, if a release order message for voice communication is received while data communication is being performed, the controller 150 does not release the data communication channel.

In the description of the mobile terminal 100, only the units required to perform operations according to an exemplary embodiment of the present invention are described. However, the present invention is not limited thereto and the mobile terminal 100 may include further units, such as a camera unit and a digital broadcasting module.

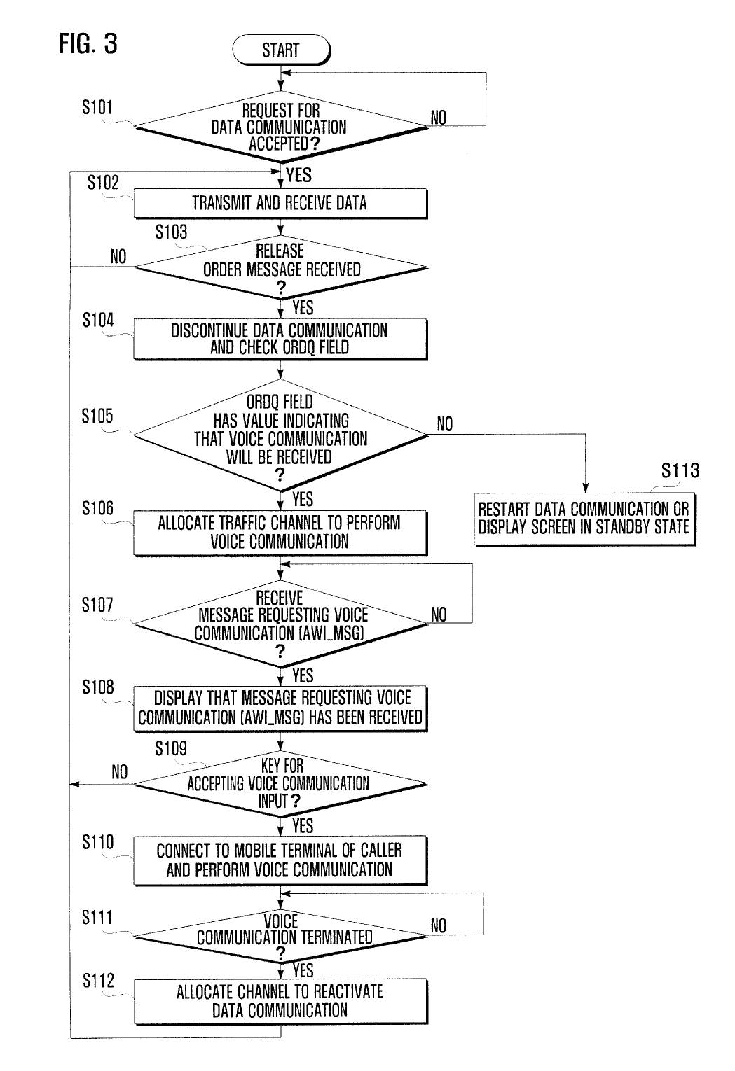

FIG. 3 is a flowchart showing a method of performing voice communication in a mobile terminal according to an exemplary embodiment of the present invention.

Referring to FIG. 3, when a request for data communication is made by the user and accepted by another party or made by another party and accepted by the user (S101), the controller 150 transmits and receives data from the other party, which may be a web server or another mobile terminal (S102).

The controller 150 determines whether a release order message is received (S103). If a release order message is received, the controller 150 discontinues data communication and checks an ORDQ field of the release order message (S104).

The controller 150 determines whether the ORDQ field has a value indicating that voice communication will be received (S105). If the ORDQ field has a value indicating that voice communication will be received, the controller 150 allocates a traffic channel to perform voice communication (S106). That is, if the ORDQ field has a value indicating that voice communication will be received, the controller 150 releases the channel used to perform data communication and converts the mobile terminal 100 from an active state to a dormant state. Further, the controller 150 allocates a traffic channel to perform voice communication in a dormant state.

The controller 150 determines whether a message requesting voice communication (AWI_Msg) has been received through the traffic channel (S 107). If a message requesting voice communication (AWI_Msg) is received through the traffic channel, the controller 150 controls the display unit 130 to indicate that a message requesting voice communication (AWI_Msg) has been received (S108).

In more detail, if a message requesting voice communication (AWI_Msg) is received through the traffic channel, the controller 150 checks the information corresponding to the caller of the AWI_Msg message. If the user subscribes to a CID service, the controller 150 determines whether the caller's phone number exists in a phonebook of the mobile terminal 100. If the caller's phone number exists in the phonebook, the controller 150 controls the display unit 130 to display a corresponding name and/or a picture stored in the phonebook. Further, the controller 150 may activate an alarm unit, for example a speaker (not shown) and/or a vibration element, set by the user.

The controller 150 determines whether the user has input a key to accept voice communication (109). If the user does input a key to accept voice communication, the controller 150 connects the mobile terminal 100 to the caller requesting voice communication using the traffic channel and performs voice communication (S110).

The controller 150 determines whether voice communication has been terminated (S111). When voice communication is terminated, the controller 150 releases the traffic channel formed with the mobile terminal of the caller and allocates a channel to re-activate the data communication discontinued by the voice communication (S112).

The controller 150 checks if there is data that was not transmitted or received when the previous data communication was terminated by the voice communication and, if the data transmission is incomplete, the controller 150 receives or transmits the remaining data using the allocated channel.

If the user inputs an ORDQ field that does not have a value indicating that voice communication will be received at step S105 and data communication is requested, the controller 150 restarts the data communication that was discontinued at step S104, or if termination of data communication is requested by the user, the controller 150 controls the display unit 130 to display with a screen in a standby state i.e. a screen in an Integrated Development Environment (IDLE) state (S113).

Further, the user can set the mobile terminal 100 to not receive voice communication requests while data communication is being performed. That is, in order to prevent data communication from being terminated due to a voice communication request, the mobile terminal 100 can be set to reject voice communication when data communication is being performed. When the mobile terminal 100 is set in this manner, the controller 150 does not release a channel that is being used for the data communication when a release order message requesting voice communication is received.

As described above, in a method of performing communication in a mobile terminal according to exemplary embodiments of the present invention, a message requesting voice communication can be received while performing data communication.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of performing communication in a mobile terminal, comprising:
performing data communication;
determining whether a release order message received while performing data communication indicates that there is a voice communication request;
allocating a traffic channel for voice communication if the release order message indicates that there is a voice communication request;
receiving the voice communication request through the traffic channel; and
displaying the voice communication request.

2. The method of claim 1, further comprising connecting the voice communication.

3. The method of claim 2, further comprising allocating a channel to perform data communication when the voice communication is terminated.

4. The method of claim 3, wherein the voice communication request comprises a caller's phone number.

5. The method of claim 4, wherein determining whether the release order message indicates that there is a voice communication request comprises:
checking an instruction condition field of the release order message.

6. The method of claim 5, wherein the instruction condition field stores identification information of the release order message.

7. A method of performing data communication comprising:
performing data communication;
setting the mobile terminal to reject voice communication requests that are received while data communication is being performed;
discontinuing data communication when a release order message is received;
determining whether the release order message indicates that there is a voice communication request;
rejecting the voice communication request if the release order message indicates that there is a voice communication request; and
allocating a channel to re-activate data communication.
